(19) United States
(12) Patent Application Publication
(10) Pub. No.: US 2014/0344397 A1
(43) Pub. Date: Nov. 20, 2014

(54) System And Method For Propagating And Assessing Programs Across A Health Network

(71) Applicant: MediResource Inc., Toronto (CA)

(72) Inventor: Paul S. Kostoff, Toronto (CA)

(73) Assignee: MediResource Inc., Toronto (CA)

(21) Appl. No.: 14/279,635

(22) Filed: May 16, 2014

Related U.S. Application Data
(60) Provisional application No. 61/824,646, filed on May 17, 2013.

(51) Int. Cl. H04L 29/08

(52) U.S. Cl. CPC H04L 67/10
USPC 709/217

(57) ABSTRACT

What is disclosed is a system for creating and distributing one or more health applications to one or more computers, said system comprising an application server having access to a programs, services and analytics database; said application server coupled to said one or more computers using a network; and said application server creates the one or more applications based on at least the information stored within the programs, services and analytics database, and transmits one or more of the one or more created applications to the one or more computers using the network.

### CROSS-REFERENCE TO RELATED APPLICATIONS

This application claims the benefit of and priority to U.S. Provisional Patent Application No. 61/824,646, filed on May 17, 2013, which is incorporated herein by reference in its respective entirety.

### FIELD OF THE INVENTION

The present disclosure relates generally to the field of healthcare and specifically to an automated system to manage patient health and wellness resources and programs within a health network.

### BRIEF SUMMARY

A system for creating and distributing one or more health applications to one or more computers, said system comprising an application server having access to a programs, services and analytics database; said application server coupled to said one or more computers using a network; and said application server creates the one or more applications based on at least the information stored within the programs, services and analytics database, and transmits one or more of the one or more created applications to the one or more computers using the network.

A method for creating and distributing one or more health applications to one or more computers, said method comprising creating the one or more applications, the creating performed by an application server having access to a programs, services and analytics database, and the creating based on at least the information stored within the programs, services and analytics database; and transmitting one or more of the one or more created applications to the one or more computers, the transmitting performed by the application server coupled to said one or more computers using a network.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 shows an exemplary embodiment of a process for creating and distributing program and service applications across a network of computers.

FIG. 2 provides a detailed description of a possible embodiment of the overall process of application server 108 distributing an application to a network of computers 103, 104, 105 and 106.

FIG. 3 shows a detailed example of a possible embodiment of application server 108 to produce application 210.

FIG. 4 shows one embodiment of application 210 sent by application server 108.

FIG. 5 shows one embodiment of how application server 108 performs a grouping operation.

FIG. 6A shows a possible use-case scenario.

FIG. 6B shows a possible use-case scenario.

FIG. 6C shows a possible use-case scenario.

FIG. 7 demonstrates one possible embodiment of how an administrator would use the system to distribute a program and receive outcomes data.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Globally, health plans and payers are shifting their funding and reimbursement models from a fee for service (FFS) model to a fee for value (FFV) model. This shift will cause major disruptions in how health care is delivered and dramatic changes in how health providers such as physicians, clinicians, nurses, pharmacists, social workers, health coaches and patients will communicate. Most recently, in January 2013, the United States implemented the Affordable Care Act (ACA) which shifts payment models for US health providers from a FFS to a FFV model. This is a major disruption in how health care is delivered since the majority of existing health care infrastructure is based on a FFS model. This has created challenges and exposed many shortfalls of prior art Electronic Medical Record (EMR) systems used to manage patients since these systems have been designed to function within a FFS model.

Under a FFV model health providers and health networks are paid an annual fixed fee or benchmark payment for each patient. FFV financially rewards health providers who reduce the annual cost of delivering care below the benchmark payment. By contrast the current FFS environment rewards health providers who see more patients since they are paid for each visit. Thus FFV models reward health providers that improve efficiencies and reduce number of visits a patient makes to a clinic. A FFV model requires health providers, such as health providers, to make significant changes in their workflow and how they practice. These changes demand enhanced communication between health providers, such as physicians. They also require health providers to empower patients by offering a broader range of education programs that improve patient self-management skills. Health networks that succeed at making these changes will be at a competitive advantage. The challenge facing health networks and the health providers that work within them is how to manage the increased number of patient programs, the frequent additions and deletions and measure their impact under a FFV model when existing infrastructure is built around an older FFS model.

Adding further challenges under new FFV models is the movement towards aggregating health networks to form a larger Accountable Care Organization (ACO), often consisting of thousands of health providers across different medical disciplines. Health networks need to find cost efficiencies by reducing the time spent by expensive health providers (such as physicians) with patients and increasing the utilization of less expensive health providers. Each health network or health provider group uses different technologies that do not communicate with one another. This creates another significant co-ordination barrier and is a major obstacle in delivering efficient care.

Health providers such as clinicians are now being offered more patient support programs than ever. Each program has a defined set of qualification criteria, rules and processes. Often the decision to provide programs is made by a central administrator without consultation with health providers. As a result, health providers are not aware of programs, become overwhelmed and have “tuned out” of recommending any of them. In some cases, EMRs have attempted to assist health providers by flagging high risk (and thus high cost) patients using alerts or pop-up reminders triggered by data stored in a patient health record (such as using lab tests results to flag patients with elevated cholesterol). Such alerts and pop-ups are not coordinated and do not give a provider any sense of an overall patient management plan. They often require health providers to complete lengthy questionnaires or supplemental patient assessments that are outside of the normal workflow routine. Furthermore such alerts are based on a defined clinical value, such as a lab test result, and leave it to the health provider to remember if a program is available. Systems that use a high number of alerts and popups have led to health providers to become annoyed at disruptions to their workflow, resulting in information overload and “pop-up fatigue.” Inevitably health providers disregard popups and alerts. Pop-ups and alerts also fail to provide health providers with ongoing feedback on patient progress from others in the network since they operate on a single system. This leads to missed opportunities, sub-optimal care and sub-optimal utilization of available programs.

There is a need for an automated system to provide health providers with patient program recommendations that is integrated into existing work flow. Such a system would allow various health providers and patients to view the overall plan, the rationale for participation, understand follow-up processes and keep updated on progress. The ideal system would also allow health providers or patients the option to personalize treatment plans and provide feedback on progress. This would enable a central administrator to track program use, satisfaction, compliance and monitor progress against allocated budgets and benchmarks in order to calculate a Return On Investment (ROI).

The system described below allows a health network administrator can communicate to a group of health providers which programs are available and the optimal mix of programs to cost-efficiently improve patient health outcomes without using alerts or pop-ups.

In particular, the system allows a program administrator of a health organization to manage, distribute and assess the return on investment (ROI) of an inventory of health and wellness programs using a computerized application, tailored to one or more patient profiles, across a wide range of health providers connected through a computer network. This system provides an improvement over the prior art, as it improves the ability of a central administrator to manage and raise awareness of a large inventory of programs and resources, make frequent changes, track patient progress and analyze program performance to determine an ROI.

The system overcomes the limitations of prior art clinical Decision Support Systems (DSS) that produce or utilize clinical care maps, clinical order sets or Clinical Practice Guidelines (CPGs). These DSS systems require personnel experienced in the field of medicine and are intended to be used by same. This system informs health providers about an inventory of patient health and wellness education programs, tracks patient progress within these programs and provides data that can be used for program ROI analysis. Many of the DSS in the prior art follow a rigid and branched “yes or no” decision tree that requires highly trained medical personnel using published evidence based clinical outcomes data to design a clinical treatment regimen. Clinical treatment regimens of other systems include recommending specific clinical steps based on patient history such as lab tests, procedures, specific medications or clinical practices. Examples of such systems include U.S. Pat. No. 7,734,482 by Vance et al, filed Sep. 27, 2006; US Patent Application 2012/0310667 by Altman et al, filed Jun. 3, 2011 and US Patent Application US2007/0143145 by Davis et al, filed Jan. 19, 2007. These prior art systems have a limitation in that they require highly trained medical personnel to construct or implement treatment plans. A further limitation of such systems is that additional work is required by health providers outside of normal workflow in order for these systems to work.

The system and method that is the subject of this specification differs significantly from a DSS in that this system and method do not require a health provider to assess a patients' medical status or history, nor does this system and method design a clinical treatment regimen for a patient. It allows administrators without any medical training to manage a series patient education programs (such as an online diabetes education program) or health resources (such as nutritional counseling or medication reviews by a pharmacist) and provide a personalized list of recommended programs that best fit a health network's ROI objectives. Health providers are then able to register patients to such programs within their existing documentation workflow.

Furthermore, the system and method that is the subject of this specification allows patient participation in managing their progress. It is known that empowering patients to participate in managing their health by, for example, sending patients targeted health messages and education resources improves outcomes and reduces costs associated with patient care. DSS systems such as the one described in U.S. Pat. No. 7,822,622 by Kaindl et al, filed Oct. 1, 2004, have a limitation in that they generally do not accommodate patient participation, since such a DSS is designed for use by medically trained health providers who understand complex medical terminology.

As stated previously, the diversity of technologies across different health networks creates a significant co-ordination barrier. Each technology normally has a different software vendor making it nearly impossible to create a consistent user interface that becomes familiar for health providers to use. The system and method that is the subject of this specification provides for simple integration into multiple software systems using a common and simplified interface. Furthermore, the mix of patient programs can change frequently, making it impractical to for multiple software vendors to change their interface or re-code to accommodate the frequency of changes required. These barriers are a major impediment towards using EMRs or other integrated software packages to assist distributing patient programs since interoperability within a health network has become a major obstacle in delivering efficient care. Unlike prior art systems, the system and method that is the subject of this specification provides the ability for a network of computers to communicate with each other and provide patient progress updates to a plurality of health providers in compliance with a recommended series of patient programs or services.

As stated previously, prior art systems often require health providers to complete lengthy questionnaires or supplemental patient assessments that are outside of the normal workflow routine. With these prior art systems, health providers are therefore likely to either forego filling these questionnaires or fill these questionnaires incompletely. For example, US Patent Application 2004/0023197 by K. Abraham-Fuchs et al, filed Jul. 3, 2003, requires an assessment of a patient's physical abilities to function. Another example of such a prior art system is US Patent Application 2013/0096942 by Bowles et al, filed Oct. 15, 2012. Unlike such prior art systems, there is no requirement for health providers to input additional information or complete patient assessment questionnaires in order for the system and method that is the subject of this specification to function.

The system and method that is the subject of this specification is an improvement over prior art systems, in that it allows patients to participate in the tracking and reporting process by adding personal data via a web, mobile or other computer system to update the primary health provider system.

Unlike prior art systems like that presented in PCT application WO2008/060853 by Egami et al, filed Oct. 31, 2007 and claiming priority to U.S. Provisional Application 60/865,036 filed Nov. 9, 2006; the system and method that is the subject of this specification does not produce a schedule and therefore does not require any connectivity with other scheduling systems to coordinate a series of clinic visits. This is a significant improvement, since connectivity and interoperability between various scheduling systems can be a major obstacle.

The system and method that is the subject of this specification provides in another aspect the ability for a plurality of computers, websites and mobile devices to communicate with each other to send and receive progress updates. The interconnectivity, which can include any health provider and the patient themselves, overcomes a major obstacle in prior art systems that rely solely on health providers to monitor and track progress. This overcomes limitations of the prior art systems because it allows a current view of which programs patients have registered to and their progress within said programs. The ability to follow a particular patient as they participate in programs or navigate through a health system or network is a major improvement over the prior art systems.

In another embodiment the system and method that is the subject of this specification provides an application that can be used as a stand-alone software product or integrated into a website or mobile device. This system can thus work without any connection to a clinical EMR, scheduling system or other computer or database that stores patient records or performs administrative tasks for health providers. In this manner it overcomes barriers faced by other systems that might rely on connectivity or interoperability with other computers or medical record databases. The application may comprise one or more programs, services, information associated with the program or service.

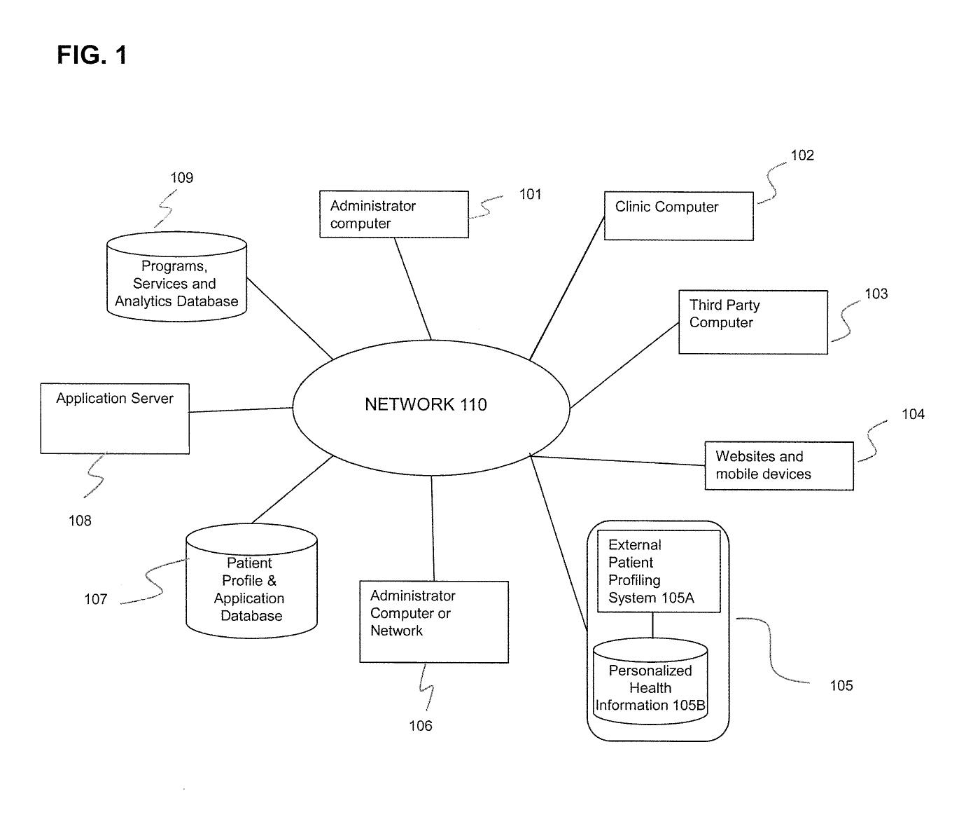

FIG. 1 shows an exemplary embodiment of a process for creating and distributing applications to one or more computers. In FIG. 1 an administrator computer 101 defines which programs, services and analytics should be entered into the system and a set of criteria or pre-requisites for patient qualification.

In another embodiment there is a programs, services and analytics database 109, connected to network 110. In another embodiment, database 109 can be directly connected to the administrator computer 101. Database 109 is used to store the programs, services and analytics entered into the system by administrator computer 101; as well as the criteria or pre-requisites. In another embodiment, other data associated with applications such as permissions, status, registration functions and targeting criteria are also stored in database 109. The analytics data stored in database 109 comprise, for example, data used for analysis of program performance.

An application server 108 receives the criteria, over, for example network 110; creates one or more applications that are stored in patient profile and application database 107; and distributes these applications to one or more computers, including clinic computer 102, third party computer 103, mobile devices and websites 104 and administrator computers 106.

Clinic computer 102 may comprise, for example, a single computer or a network of clinic computers. Third party computer 103 may comprise, for example, laptops and personal computers. Mobile devices and websites 104 may comprise smartphones, tablets, mobile sites, or even social media websites.

In another embodiment the application server 108 creates the one or more applications using the information stored in databases 107 and/or 109. For example, the application server 108 may receive a set of available programs and services directly from database 107 and create the one or more applications using data on existing applications stored in database 109. In a further example, the application server 108 creates a library of applications that associates said selection criteria stored in database 107, with said programs and services, also stored in database 107.

In another embodiment the application server 108 can be connected to external system 105 comprising external patient profiling system 105A and/or database 105B containing personalized health information and/or analytics to increase the specificity of an application or assist the administrator in identifying patient types that require a particular program and service application. In another embodiment the administrator computer 101 would be connected directly with the external system 105. External system 105 may also comprise expert systems, and recommender systems. By connecting administrator computer 101 to external system 105 which comprises patient profiling and expert systems, administrators do not need to rely on the use of clinical practice guidelines, order sets or care maps. This reduces the necessity for administrators to have a high level of medical knowledge, unlike prior art systems that require expensive and scarce medically trained personnel to setup or assess programs.

In another embodiment the patient profile and application database 107 and the programs, services and analytics database 109 can be connected to other administrator computers or a network of computers 106 to share patient criteria, feedback, ROI data or assist other administrators in the development of their own applications. Such connectivity can be used to share data or information to assist different administrators within or between organizations with application development.

In another embodiment, all of 101-109 are interconnected with each other by network 110. Network 110 is, for example, the Internet, intranet, wide area network, virtual private network, telephone or local area network. In addition, the network 110 could be a wireless, wired, satellite, optical network or use any form of physical media. The network 110 may itself be comprised of two or more interconnected subnetworks.

In yet another embodiment one or more functions of application server 108 may be performed by one or more of computers 101, 102, 103, 104 or 106. Application server 108 can be implemented in hardware, software, or a combination of hardware and software. In addition, various software technologies and programming languages can be used in these implementations. In addition, application server 108 may be implemented as a single server or distributed over multiple servers. The multiple servers can be in one location or at multiple locations, and interconnected with each other using various technologies known to one of skill in the art. In a further embodiment, the application server is configured to operate in real-time.

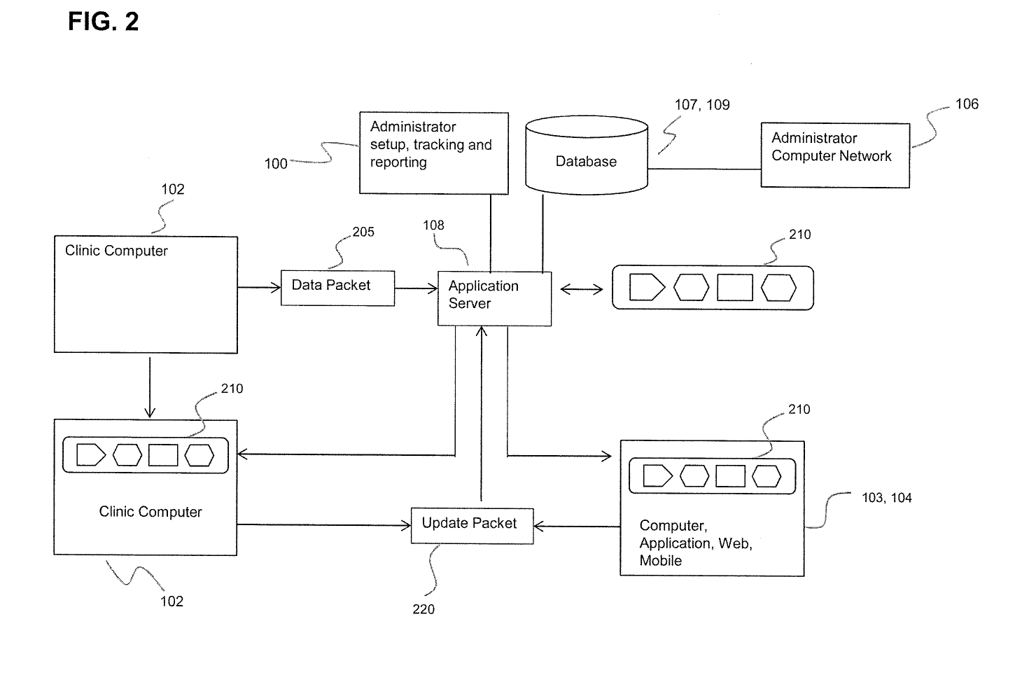

FIG. 2 provides a detailed description of a possible embodiment of the overall process of application server 108 creating and distributing an application to one or more computers 102, 103, 104 and 106. In this embodiment, the application server 108 receives a set of patient programs and services from administrator computer 101 and stores them as a library of available programs and services in databases 107 and/or 109. Administrator computer 101 can add additional data about the programs and services such as; status, description, selection criteria for enrollment, pre-requisites, permissions, availability or other information. In another embodiment program and service data could be stored on administrator computer 101 without the need for external storage in databases 107 and/or 109. In another embodiment, administrators include programs directed at health providers. For example, such professional programs could be used to track health provider activities for billing purposes or incentivize health providers for recommending programs to patients. Such tracking of health provider participation in the process provides administrators with valuable information about which health providers or clinics are successful at implementing or obtaining patient participation.

In yet another embodiment databases 107 and/or 109 could be connected to an administrator network of computers 106 so that different networks could access databases 107 and/or 109 for the purpose of sharing data, comparing performance and outcomes of a series of education programs/services or allowing direct communication between different administrators.

In yet another embodiment a plurality of computers consisting of 101, 102, 103, 104 or 106 could form an interconnected network using, for example, a subnetwork in network 110, for the purposes of communicating information about programs and services through a website, mobile device or social media application. In this way health providers and administrators can inform each other of what has worked for them within their practice environment and may then add, subtract or modify program paths according to their preference rather than having to follow rigid protocols of other systems using CPGs, order sets or care maps.

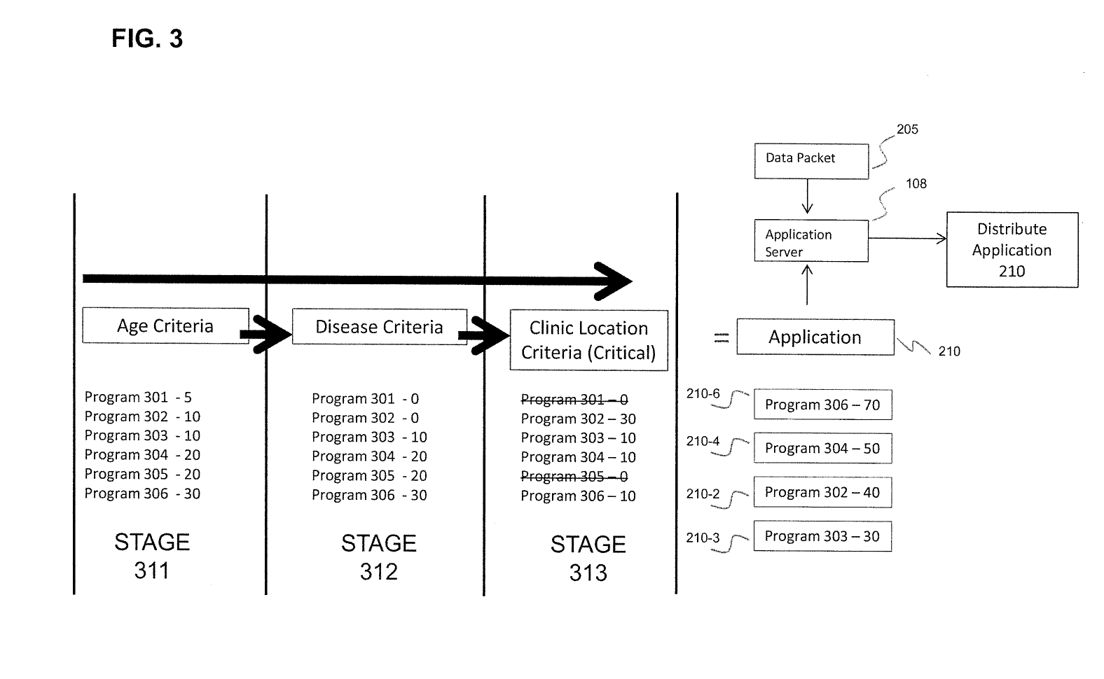

In one embodiment, application server 108 can be used to align data packet 205 with appropriate programs/services, associated data, and applications stored on, for example, databases 107 and/or 109 and administrator computer 101. Based on this information, application server 108 can be used to create one or more applications 210. An example of this process will be described below with reference to FIG. 3.

In another embodiment clinic computer 102 may trigger application server 108 to initiate the process of creating application 210 by sending one or more data packets 205 containing data about clinic computer 102, such as the location of clinic computer 102, names of health providers or other information stored on clinic computer 102, such as patient information data, or any of its associated databases. Application server 108 analyzes data packet 205 optionally by referral to analytics stored on an external system 105, and create one or more applications 210.

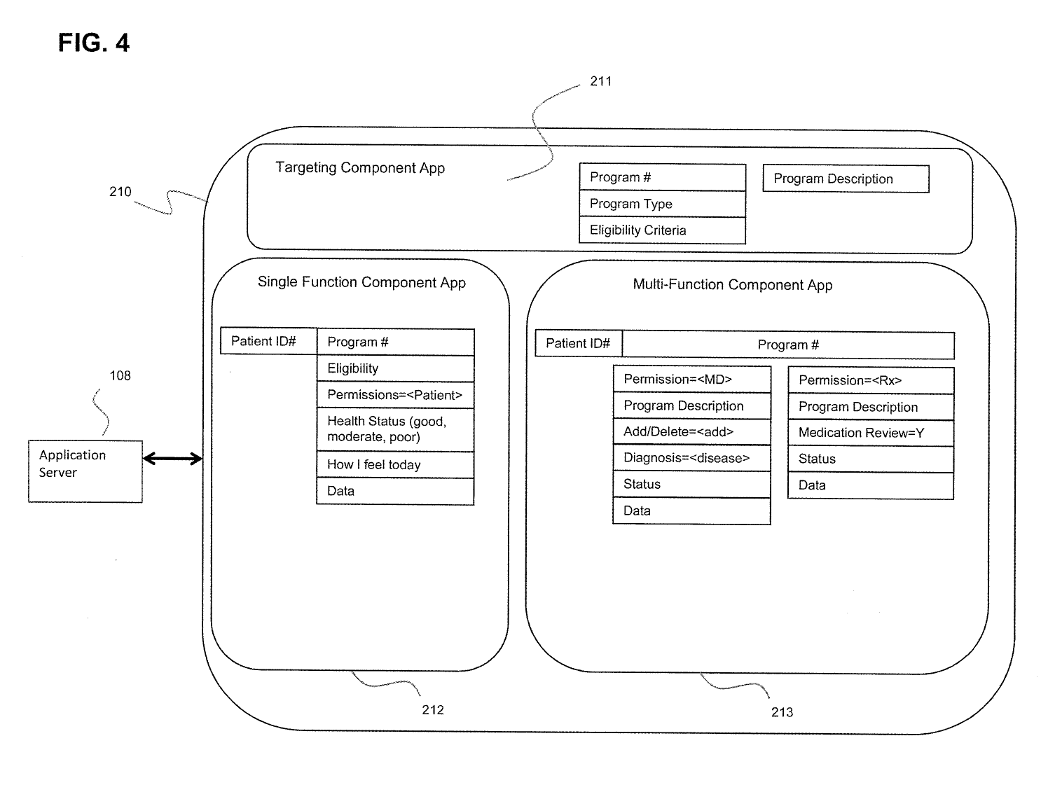

In another embodiment, the one or more applications 210 created by application server 108 are used to create a multi-function application. The multi-function application can then be transmitted to one or more computers 102, 103, 104 and/or 106. An example will be presented in FIG. 4.

In another embodiment, when the one or more applications 210 are transmitted from application server 108 to clinic computer 102, the user of the system sees a personalized list or grouping of programs on clinic computer 102. In another embodiment application 210 may be displayed as one or more graphical icons displayed within an existing patient management software program such as an EMR or pharmacy management system. In another embodiment application 210 can be used to modify a computers menu system, display lists, matrices or other display methods. In another embodiment application 210 may be presented within a website, stand-alone software program or mobile device. This flexibility in display overcomes any user interface or space limitations of software package such as EMR or pharmacy management system.

In another embodiment the EMR system may contain a single program icon or menu item on a display on, for example, clinic computer 102, that when activated by a user or through an automated process, sends data packets 205 to trigger application server 108 to initiate an iframe, web service or other application to present one or more applications. Application server 108 will then transmit these one or more applications to one or more computers.

In another embodiment, the status of the application 210 is transmitted from the one or more computers back to the application server 108. The status can be modified through user activities such as clicking on an application icon, inputting information or through an automated process that does not require user actions. The application server 108 then associates the application 210 status with the patient, clinic, and health provider; and makes the status available to the one or more computers through email, mail, text messaging, SMS, MMS or telephone or through a print out from a printer connected to said application server or one or more computers. In one embodiment, as will be discussed below, the status of the application is included within an update packet 220.

In one embodiment, the application 210 contains a list of programs and services that can be embedded into different computers across a network for example using various technologies such as iframes, web services, Windows Communication Foundation (WCF), Extended Markup Language (XML), application programming interface (API) or other technologies that embed applications, and can also be targeted to specific groups. In another embodiment, at least one of the one or more applications is targeted to at least one of the one or more computers 102, 103, 104 and/or 106.

In another embodiment, the application 210 comprises program information, and functionalities comprising at least one of permissions, registration functions and targeting criteria. If, for example, the application 210 is a multi-function application such as the one described in FIG. 4, then in one embodiment, these functionalities are within the component applications.

In one embodiment, using the one or more applications leads to the delivery of personalized health information packages targeted to patients. These targeted personalized health information packages are generated by, for example, the application server 108, using the information stored in at least one of external system 105, database 107 and database 109. A process to generate such targeted and personalized packages was demonstrated in U.S. patent application Ser. No. 13/526,736 by Kostoff et al, filed Jun. 19, 2012 and herein incorporated by reference as if reproduced in its entirety. These packages can then be delivered to the one or more computers, using the channels most appropriate to the patients. In another embodiment, the application server 108 generates the personalized targeted health information packages within the framework of a sequential behavior change process as described in U.S. patent application Ser. No. 13/526,736.

In another embodiment, programs within an application can be assigned a tracking code that links to a third party billing process, or to reimburse health providers or health organizations. Then, when the application is used, the tracking code and the linked processes are activated. In another embodiment, programs within an application can be used by, for example, the application server 108, to monitor patient status for either third party billing or reimbursement purposes, using the tracking code or linked process.

In another embodiment administrators may receive the status of program acceptance by update packets containing information on patients' or health providers' actions on applications. For example, if upon analysis of a series of update packets by application server 108, it is discovered that a majority of health providers have decided to delete an application icon or fail to recommend it to patients, then it would signal to administrators that a particular program may require modifications. Such information related to program analytics may optionally be stored in database 109.

In another embodiment application server 108 sends application 210 to one or more computers 102, 103, 104 or 106 without any trigger from any other computer, but instead based on a schedule or another trigger such as a registration by a clinic receptionist on a different computer or system. This allows administrators to implement applications into the workflow of health providers without any disruption to their current routine.

In another embodiment clinic computer 102 or another system would trigger the development of application 210 on application server 108 but the system would be configured so that clinic computer 102 did not receive application 210. In this manner the health provider operating clinic computer 102 would not be aware of any plan created for said patient. Instead application 210 would be distributed to any or all of computer 103, 104 or 106.

In yet another embodiment application 210 may be sent using other electronic means or be compiled for use in by other software such as email, text messaging or websites. This overcomes the limitations of other systems that rely on notifications such as pop-ups directed at health providers using clinic computer 102 to participate in the patient management process. This also offers a significant advantage by automating the entire process so that it is completely transparent to a health provider such as a physician, thus removing the need for health provider involvement. This reduces the workload of health providers who are often too busy or not willing to act on system reminders or to be involved in the development of such patient management plans.

In yet another embodiment, the application server 108 is configured to de-identify a record before transmission to the one or more computers in compliance with government regulations, such as the United States Health Insurance Portability and Accountability Act of 1996 (HIPAA) Privacy Rule. Guidance for methods and approaches to de-identify records have been provided at, for example, http://www.hhs.gov/ocr/privacy/hipaa/understanding/coveredentities/De-identification/guidance.html, herein incorporated by reference as if reproduced in its entirety.

In yet another embodiment application server 108 can notify clinic computer 102 that an application 210 has been generated by sending an email or other electronic means to one or more users of clinic computer 102. Such a notification would be useful in the event a health provider wishes to forward the recommendations contained within the application to people who are not part of the computer network or do not have software that can de-compile application 210.

In one embodiment ongoing user activity and data input from computer 103, 104, 105 or 106 directly or indirectly on application 210 results in secondary data and generation of one or more update packets 220 that are sent to application server 108 to append data to data stored in database 107 and/or 109. In one embodiment, this results in synchronous and asynchronous interactive processes to update different users of the overall system on changes to the overall program. In another embodiment, the application can record and transmit compliance of patients, health providers and clinics with recommended programs and patient progress within one or more update packets 220. In another embodiment, only authorized users can add, delete or modify the application or its status, which also leads to the generation of one or more update packets 220.

The update packet 220 contains data such as application 210 status, acceptance/rejection of programs suggested via the automated process, registration information, participation, feedback, language restrictions, lifestyle preferences, personal information, administrative data, data entered by a patient that is not normally available (such as patient health plan number), patient status or other data. This ability to track progress or append data overcomes limitations of other systems that do not allow simultaneous and/or real time monitoring of patient progress by multiple computers, health providers or patients (or any authorized user of the system such as caregivers).

Update packet 220 enables greater personalization and ongoing modifications. A critical aspect of improving health is to allow health providers, patients and caregivers to participate in personalizing an approach to treatment as well as providing efficient mechanisms for various members of a health team, including those without medical training, to communicate progress and obtain feedback. In a further embodiment, the application server 108 associates the update packet 220 with at least one of a patient record, health provider record and clinic record, by, for example, cross-referencing the information in the update packet 220 with information contained within one of databases 107 and/or 109; or with external system 105.

This system overcomes limitations of other systems that do not allow such personalization and communication. Systems that use CPGs, order sets or care maps may be too rigid and do not provide enough personalized treatment options since they rely on published evidenced-based clinical protocols that apply to a mass population. This system differs significantly from any of those systems since it does not develop clinical protocols and offers tremendous flexibility to accommodate a personalized approach without the need for skilled medical personnel who understand complex medical terminology. This system provides health providers the option to select from a wide range of programs that administrators have pre-screened and determined apply to a particular clinic population or individual. It then narrows the list of programs that are presented to health providers such as social workers who are not medically trained professionals so they may recommend the most appropriate programs that personalize a disease management plan for patient. Patients and caregivers can then participate in modifying a plan to adapt to their personal situation. Such personalized approaches improve adoption of healthy lifestyle changes by patients by over 70% compared to traditional clinical approaches of prior art systems. It provides health providers the authority to modify the plan to a high degree and allows administrators to monitor and analyze ongoing progress, ROI and outcomes in real time if appropriate. Furthermore it allows patients and caregivers to also participate and modify the plan to their personal situation.

FIG. 3 shows an example of a pipelined process to analyze one or more incoming data packets 205 to create one or more applications 210. In this embodiment an administrator using administrator computer 101 has stored data on 6 different patient programs 301-306. For example, based on one or more data packets 205 sent from a particular clinic at a particular location, an administrator using administrator computer 101, determines that there is a need to build an application for elderly, diabetic patients at that location. Therefore, an appropriate set of selection criteria to select programs to build the application is a set comprising age, disease and clinic location.

Based on this set, the administrator then scores the relevancy of programs using a pipelined process. An example pipelined process 310 with 3 stages 311, 312 and 313 is shown in FIG. 3.

In stage 311, the administrator scores the relevancy to the age criteria. In this example program 301 is not relevant for elderly patients but program 306 is highly relevant for patients that are elderly.

In stage 312, the administrator can then score each program by relevancy to the disease criteria. For this example, the disease considered is diabetes. Program 301 is not relevant whatsoever for diabetes while program 306 is highly relevant.

In stage 313, the administrator can then score each program by relevancy to the clinic location criteria. This is considered a critical criteria, as programs which are not offered at a particular clinic location, are excluded. In this example program 301 and program 305 are not offered at a particular location and are excluded.

The scores for the remaining programs 302, 303, 304 and 306 are then used to rank the programs. It is determined that program 306 has the highest relevancy score of 70.

Application server 108 is then used to build application 210-6 using program 306, and package application 210-6 into application 210.

However, it is possible that for different age and disease criteria, one of programs 302, 303 and 304 may have higher relevancy, and applications 210-2, 210-3 and 210-4 based on these programs may be packaged into application 210.

Application 210 is then distributed to one or more computers using application server 108 upon creation. In one embodiment, application 210 may be stored in patient profile and application database 107, and when data packets 220 are sent from the same clinic in the future for an elderly patient with diabetes, application 210 is retrieved from application server 108 and transmitted to, for example, a website or a mobile device 104 for the elderly patient.

FIG. 4 shows another embodiment of the creation of an application. In FIG. 4, the creation of a multi-function embodiment of application 210 is detailed. In this embodiment application 210 could contain one or more component applications 211, 212, and 213. This allows several administrators to participate in application development and expands the functionality of a single application to enable sub-specialization by administrators.

For example, a first administrator may choose to include component application 211, which is a targeting component application. The administrator may retrieve this application from application database 107 of FIG. 1 using application server 108.

In another example, one administrator may have a great depth of knowledge about health behavior models and thus identified that self-reported health status is a key variable in improving health. This administrator develops a single-function component application 212 to, for example, obtain information from a patient on their self-reported health status. Using application server 108, application 212 is developed based on, for example, information stored in both databases 107 and 109 of FIG. 1.

Another administrator may have a depth of knowledge around cost drivers associated with various diabetes medications and develops a multi-function component application 213 that enables a doctor to register patients with diabetes for a medication review and permits a pharmacist to complete this review. Using application server 108, application 213 is developed based on data stored in external system 105, database 107 and database 109 of FIG. 1.

Using application server 108, these component applications can then be compiled in one or more combinations to form the single multi-function application 210, which is then transmitted by application server 108 to one or more computers. This overcomes the limitation of other systems that do not allow various members of a health care team to participate in managing and tracking patient progress using a computer network.

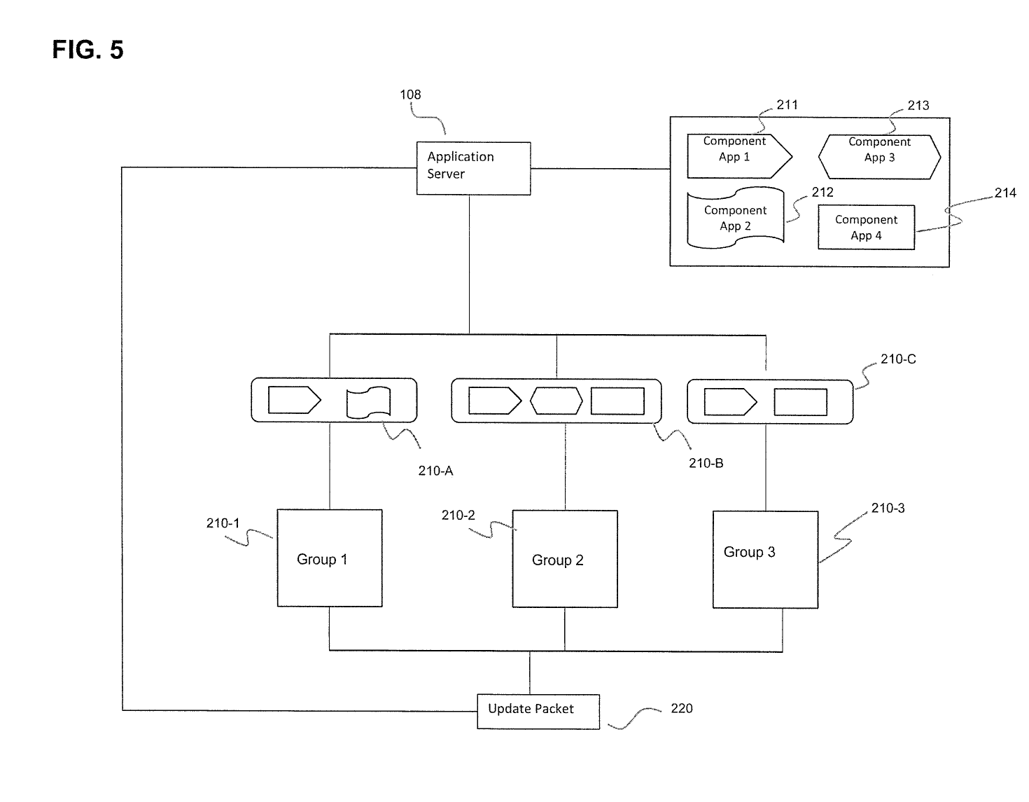

FIG. 5 shows one embodiment of how application server 108 performs a grouping operation to compile component applications 211, 212, 213, and 214 in various combinations to create multiple renditions of application 210. In another embodiment an administrator may add additional targeting criteria within each component application. A particular combination of component applications would result in additional targeting of application 210 to create one or more targeted versions 210-A, 210-B and 210-C, addressed to one or more user groups 210-1, 210-2, 210-3 or computer systems respectively. One or more users or groups or computer systems could then interact with application 210 resulting in update packet 220 that is sent to application server 108 to append one or more patient records; or provide data for analysis.

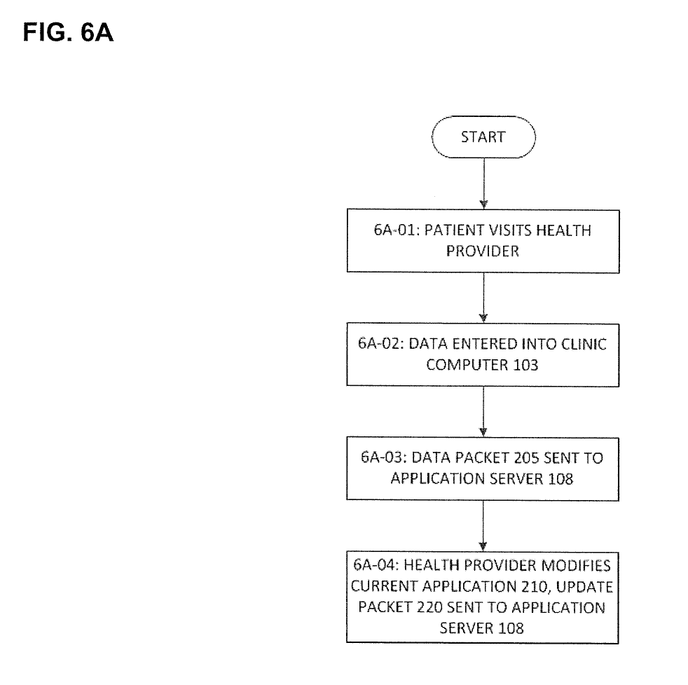

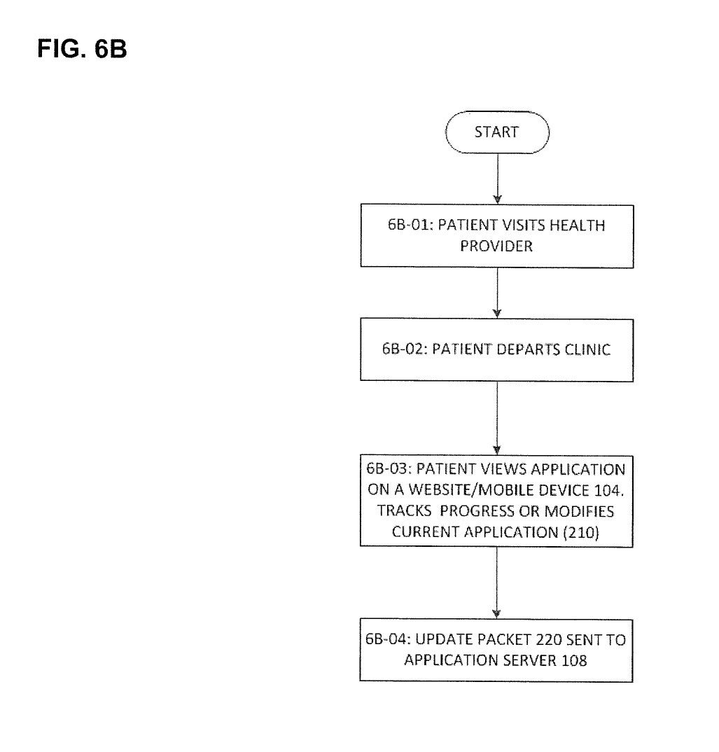

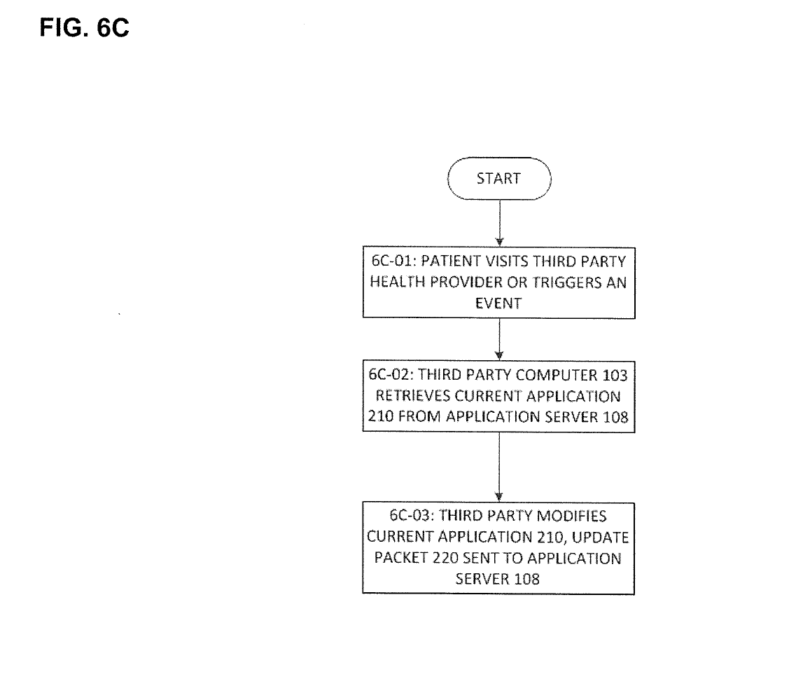

FIGS. 6A, 6B and 6C show possible use-case scenarios involving a primary health provider, a patient and a third party user. In each of these scenarios a user interacts with the initial application 210 to update information about a patient's status. The computer of each user then sends an update packet 220 to server 108. This results in the original application 210 being modified on subsequent iterations, which are then propagated to all users of the system to create a synchronous update on patient progress. For example, in one embodiment, a secondary application resulting from the modification of the original application is created and transmitted to the one or more computers.

In FIG. 6A, in step 6A-01, the patient visits a health provider. In step 6A-02, data relevant to the patient which was gathered during the visit is entered into the clinic computer 102. In step 6A-03, data packet 205 is sent to application server 108. In step 6A-04, the health provider modifies the current application 210, and an update packet 220 is sent to application server 108.

FIG. 6B shows another possible use-case scenario. In step 6B-01, the patient visits a health provider, and data is gathered during the patient visit. After the patient departs the clinic in step 6B-02, the patient views the application on a website on a computer, or on a mobile device 104 via an app. The patient tracks his/her progress and modifies the current application 210. In step 6B-03, the update packet 220 is sent to application server 108.

FIG. 6C shows a third use-case scenario. In step 6C-01, a patient visits a third party health provider or triggers an event. An example of an event includes a pharmacy visit, lab visit, or a counseling session. Third party computer 103 retrieves current application 210 from the application server 108 in step 6C-02. In step 6C-03, the third party computer 103 modifies the current application 210, and an update packet 220 is sent to application server 108.

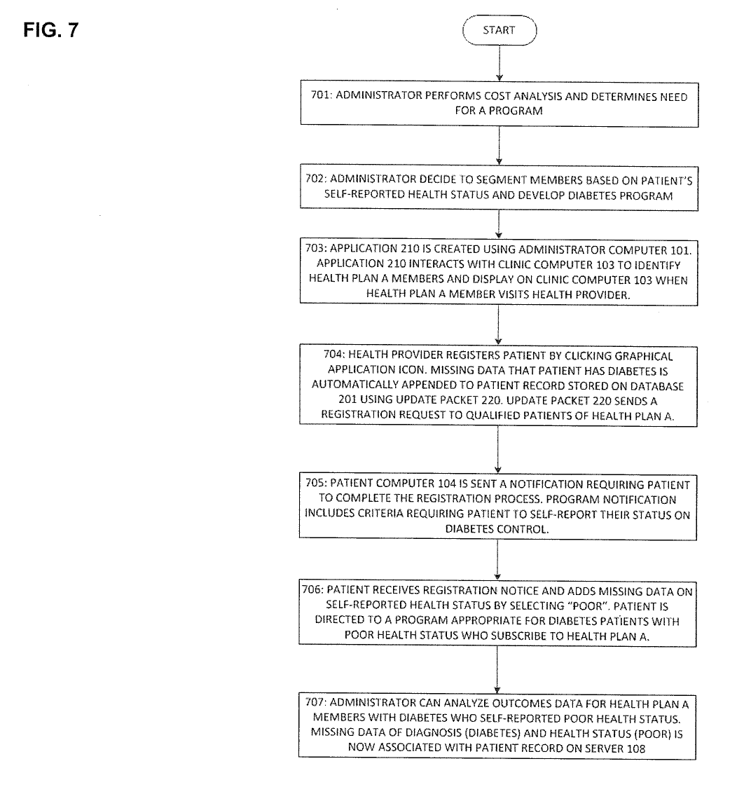

FIG. 7 demonstrates one possible embodiment of how an administrator would use the system to distribute a program and receive outcomes data. In this embodiment, in step 701 an administrator has analyzed data from database 107 and/or 109 to identify that costs for members who subscribe to “Health Plan A” are too high. The health network administrator discusses the situation with administrators of Health Plan A and they collectively determine that a program is warranted for Health Plan A members. In the rest of this example, the example of a diabetes program is used. However, this method is generalizable to any program.

In step 702, the administrators further decide to segment members into 3 sub-categories based on a patient's self-reported health status. The health network administrator then retrieves and implements a web-based diabetes education program stored in database 109 of FIG. 1. This program is suitable for Health Plan A members based on their self-reported health status of i) poor; ii) moderate; or iii) excellent. The title and description of this program is entered into database 107 and/or 109.

The administrator reviews the network IT infrastructure and determines that their current EMR system only contains data that can identify Health Plan A members. The EMR system does not contain any data fields for i) a diagnosis of diabetes or ii) self-reported health status. With other systems these 2 missing data fields would pose a significant barrier to implement this targeted education program. However this system overcomes the limitations of the prior art since it allows such targeting without the need for additional cumbersome and time consuming data entry, system modifications, patient interviews or questionnaires.

In this example of FIG. 7, in step 703 an administrator accesses administrator computer 101 and creates a new application 210 using application server 108. Application 210 is distributed to one or more clinic computers 102 using application server 108, and is constructed in a manner such that it triggers clinic computer 102 to send data packet 205 to application server 108 when a member of Health Plan A visits a health provider. Application 210 authorizes health providers to register patients of Health Plan A if they have diabetes.

In one embodiment, in step 704 registration is completed by a health provider clicking a graphical application icon that appears in-line with the normal work flow of documenting a patient encounter within an EMR running on clinic computer 102 (without using a popup or alert). This inline click process overcomes limitations of other systems that require additional and time consuming processes by health providers to perform a registration process, complete questionnaires, apply care maps, order sets, CPGs or consult with patients. Once clicked this system automatically and without any further action on behalf of a health provider automates the process of appending a patient record by sending update packet 220 to application server 108 to add the diagnosis of diabetes. Update packet 220 also sends an automated registration request to a patient. Other embodiments of this registration process may include a health provider clicking on a menu item or patients automatically becoming enrolled unless a health provider takes and action to “de-register” the patient.

In step 705 a member of Health Plan A receives an automated notification from a health provider that they have been registered for a diabetes health program, on for example, mobile device 104, and notifies them to visit the diabetes program website. Application 210 is constructed in a manner that authorizes patients to input data on their self-reported health status and has been incorporated into the diabetes program website.

In step 706, the patient visits the diabetes program website and completes the registration by entering their self-reported health status data as “poor.” Update packet 220 sends data to application server 108 that appends the patient record stored in database 107 of FIG. 1, adding the status of “poor” to patient record. Application 210 may be constructed in a manner that allows ongoing status checks during the education program, sending a series of update packets 220 to track progress over time as patient progresses from “poor” to “excellent” health status.

In step 707, after the patient completes the diabetes education program the administrator can now analyze outcome data for specific sub-segments of patients with poor, moderate or excellent health status. This ability to segment patients and analyze outcomes of discrete sub-segments provides a significant advancement in the areas of health and behavior research. The system and method that is the subject of this specification overcomes the limitations of other systems that require too much time or participation by health providers, rely on legacy databases that are not able to extract critical patient data fields or are not able to capture critical data fields that allow for detailed segmentation.

Furthermore there are many EMR software providers serving a wide range of organizations, health providers and clinical settings. They must design their systems and database structures for a mass audience and base their design around accepted documentation practices or common structures for clinical data such as lab data, industry standardized diagnostic or billing codes. EMR providers cannot accommodate nor predict the diverse range of needs or frequency of changes from individual health provider organization to impact their organizational cost drivers and thus do not provide for storing such structured data and making interface changes within their EMR systems.

For example, in FIG. 7 it was determined that a patient's self-reported health status, which is a non-clinical data point, was of critical importance. However, an EMR provider would not include such a data field into their system since such data may only be important for a select number of customers and is unlikely to be an industry accepted data point. Furthermore an administrator may determine that collecting such information may not be necessary after a short period. Therefore EMR providers may not want to include such data fields or even allow for short-term changes to their user interface, as there is a risk that they will incur large costs in making then removing such changes, or including functionalities that allow for such short-term changes. As a consequence EMR systems potentially neither accommodate the collection and storage of customized data nor allow for short-term changes to their user interface. Thus the system and method that is the subject of this specification overcomes these potential limitations of EMR systems.

In another embodiment health providers or patients can enter notes, rate the quality of a program or service, communicate special instructions, provide feedback or communicate with other patients or health providers as part of a social media program. Examples of social media programs include, for example, those specially geared towards medical use such as PatientsLikeMe® (see, for example, http://www.patientslikeme.com/, retrieved May 17, 2013), HealthTap® (see, for example, https://www.healthtap.com/ retrieved Apr. 28, 2013).

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A system for creating and distributing one or more health applications to one or more computers, said system comprising:
an application server having access to a programs, services and analytics database;
said application server coupled to said one or more computers using a network; and
said application server
creates the one or more applications based on at least the information stored within the programs, services and analytics database, and
transmits one or more of the one or more created applications to the one or more computers using the network.

2. The system of claim 1, wherein at least one of the one or more applications is targeted to at least one of the one or more computers.

3. The system of claim 1 wherein said application is associated with a clinic, health provider or patient.

4. The system of claim 1 wherein one of said one or more computers generates and transmits to said application server an update packet containing information about said application status, said application server associating said application status with said patient, said clinic, said health provider and said application status being made available to at least one of said one or more computers.

5. The system of claim 1 wherein said application server is connected to at least one external system that either analyzes patient profiles or provides health information.

6. The system of claim 1, further comprising either
an administrator computer, or
a network of administrator computers
connected to the application server, wherein the administrator computer and the network of administrator computers have access to the programs, services and analytics database.

7. The system of claim 1 wherein a first of said one or more computers generates and transmits to said application server at least one data packet containing information about said first computer, a clinic or a patient.

8. The system of claim 7 wherein said application server analyzes said at least one data packet and uses said analysis to generate a first of said one or more applications.

9. The system of claim 8 wherein one of said one or more computers transmits an update packet to said application server.

10. The system of claim 9 wherein said application server analyses said update packet, modifies the first application based on said analysis to generate a secondary application, and transmits the secondary application to the one or more computers.

11. The system of claim 9 wherein said application server associates said update packet with at least one of a health provider record, clinic record and patient record.

12. The system of claim 1, further wherein a plurality of the one or more created applications, are combined to form a multi-function application, and wherein said application server transmits the multi-function application to said one or more computers.

13. The system of claim 1 wherein at least one of said one or more applications records and transmits information associated with compliance with one or more requirements of a program by one or more patients, one or more health providers and one or more clinics.

14. The system of claim 1, wherein said application server de-identifies a record in compliance with one or more government privacy regulations.

15. A method for creating and distributing one or more health applications to one or more computers, said method comprising:
creating the one or more applications,
the creating performed by an application server having access to a programs, services and analytics database, and
the creating based on at least the information stored within the programs, services and analytics database; and
transmitting one or more of the one or more created applications to the one or more computers,
the transmitting performed by the application server coupled to said one or more computers using a network.

16. The method of claim 15, further comprising
generating, by the one or more computers, an update packet containing information about a status of a first of said one or more application;
transmitting, by the one or more computers, the update packet to the application server;
associating, by said application server, the first application status with a patient, clinic and health provider; and
making said first application status available to at least one of said one or more computers.

17. The method of claim 15, further comprising
generating, by a first of said one or more computers, at least one data packet containing information about the first computer, a clinic or a patient; and
transmitting the at least one data packet to the application server.

18. The method of claim 17, further comprising
analyzing, by the application server, the at least one data packet; and
generating a first application of said one or more applications based on said analyzing.

19. The method of claim 18, further comprising
transmitting an update packet to the application server, said transmitting performed by one of said one or more computers, and further comprising
analyzing, by the application server, said update packet;
modifying, by the application server, the first application based on said analyzing;
generating, by the application server, a secondary application based on said modifying; and
transmitting, by the application server, the secondary application to the one or more computers.

20. The method of claim 15, further comprising the application
recording information associated with compliance with one or more requirements of a program by one or more patients, one or more health providers and one or more clinics; and
transmitting said information to the application server.
